(19) United States
(12) Patent Application Publication
(10) Pub. No.: US 2022/0235803 A1
(43) Pub. Date: Jul. 28, 2022

(54) SNAP-FIT STRUCTURES AND ASSEMBLY STRUCTURES

(71) Applicants: K-Tronics (Suzhou) Technology Co., Ltd., Suzhou (CN); BOE Technology Group Co., Ltd., Beijing (CN)

(72) Inventor: Guang YANG, Beijing (CN)

(21) Appl. No.: 17/498,429

(22) Filed: Oct. 11, 2021

(30) Foreign Application Priority Data
Jan. 22, 2021 (CN) 202110093914.7

(51) Int. Cl. F16B 5/06

(52) U.S. Cl. CPC F16B 5/0664

(57) ABSTRACT

Snap-fit structures and assembly structures are provided. A snap-fit structure may include a metal plate including a first plate surface and a second plate surface disposed opposite to each other, and a plate side surface connected between the first plate surface and the second plate surface; and a snap integrally extending from the first plate surface and including a first surface contiguous with the plate side surface.

### CROSS-REFERENCE TO RELATED APPLICATIONS

The present disclosure claims a priority to Chinese patent application No. 202110093914.7 filed on Jan. 22, 2021 and entitled “ASSEMBLY STRUCTURES AND SNAP-FIT STRUCTURES”, which is incorporated herein by reference in its entirety.

### TECHNICAL FIELD

The present disclosure relates to the field of assembly technology, and in particular to a snap-fit structure and an assembly structure.

### BACKGROUND

With the improvement of living standards, speaker devices have attracted more and more attention.

People may play songs on demand or learn about the weather forecast through a speaker device. People may also control smart home devices through the speaker device, such as setting a temperature of an air conditioner, and turning off or on a TV. In order to improve an operation performance of the speaker device, a metal plate may be mounted on a workpiece of the speaker device. However, the metal plate cannot be mounted on the workpiece.

### SUMMARY

Embodiments of the present disclosure provide a snap-fit structure and an assembly structure.

According to an aspect of the embodiments of the present disclosure, there is provided a snap-fit structure, including:

a metal plate including a first plate surface and a second plate surface disposed opposite to each other, and a plate side surface connected between the first plate surface and the second plate surface; and

a snap integrally extending from the first plate surface and including a first surface contiguous with the plate side surface.

In an embodiment, the first surface is perpendicular to the first plate surface.

In an embodiment, in an extension direction of the snap, the snap includes a first extension section and a second extension section connected with each other, and the second extension section is located on a side of the first extension section away from the metal plate and has a cross-section that gradually decreases in a direction away from the first extension section.

In an embodiment, the snap is plate-shaped, and the first surface is perpendicular to a thickness direction of the snap.

In an embodiment, the snap includes a second surface disposed opposite to the first surface and a side surface connected between the first surface and the second surface; and

in an extension direction of the snap, the snap includes a first extension section and a second extension section connected with each other, and the second extension section is located on a side of the first extension section away from the metal plate and has a cross-section that gradually decreases in a direction away from the first extension section; and a portion of the side surface of the snap at the second extension section is a smoothly transitioned curved surface.

In an embodiment, the snap includes a necked portion located between both ends of the snap in an extension direction of the snap, and the necked portion has a cross-section smaller than that of a portion of the snap abutting the necked portion.

In an embodiment, the snap-fit structure further includes a bending portion integrally extending from the plate side surface, and the bending portion and the snap are located on a same side of the metal plate in a thickness direction of the metal plate, such that a catching space is formed between the bending portion and the snap.

In an embodiment, the bending portion extends in a same direction as the snap.

In an embodiment, the bending portion is plate-shaped and is parallel to the snap.

According to another aspect of embodiments of the present disclosure, there is provided an assembly structure, including:

a workpiece provided with a catching groove; and

the snap-fit structure as described above, where the snap can be fitted in the catching groove.

In an embodiment, the workpiece includes an assembly surface and a stop surface, the catching groove is provided in the assembly surface, the first plate surface mates with the assembly surface, and the plate side surface mates with the stop surface.

In an embodiment, a flexible membrane is provided on the stop surface, and the plate side surface abuts against the flexible membrane.

According to yet another aspect of embodiments of the present disclosure, there is provided an assembly structure, including:

a workpiece provided with a catching groove; and

the snap-fit structure as described above, where the snap can be fitted in the catching groove, and a portion of the workpiece is located in the catching space between the bending portion and the snap.

In an embodiment, the snap includes a second surface disposed opposite to the first surface, and a gap is formed between the second surface and a side wall of the catching groove.

### BRIEF DESCRIPTION OF DRAWINGS

FIG. 1 is a schematic diagram illustrating a snap-fit structure in the related art.

FIG. 2 is a schematic diagram illustrating a snap-fit structure according to an embodiment of the present disclosure.

FIG. 3 is a schematic diagram illustrating a snap-fit structure according to an embodiment of the present disclosure viewed from another perspective.

FIG. 4 is a partial schematic diagram illustrating a snap-fit structure according to an embodiment of the present disclosure.

FIG. 5 is a schematic diagram illustrating a first extension section and a second extension section of a snap-fit structure according to an embodiment of the present disclosure.

FIG. 6 is a schematic diagram illustrating an assembly structure according to an embodiment of the present disclosure.

FIG. 7 is a top view illustrating an assembly structure according to an embodiment of the present disclosure.

FIG. 8 is an exploded view illustrating an assembly structure according to an embodiment of the present disclosure.

FIG. 9 is a cross-sectional view taken along a line A-A in FIG. 7.

FIG. 10 is a partial schematic diagram illustrating an assembly structure shown in FIG. 9.

FIG. 11 is a schematic diagram illustrating a workpiece in an assembly structure according to an embodiment of the present disclosure.

### DETAILED DESCRIPTION

Exemplary embodiments will be described in detail herein, and examples thereof are illustrated in the drawings. When the following description refers to the drawings, the same numbers in different drawings indicate the same or similar elements, unless otherwise indicated. Implementations described in the following exemplary embodiments do not represent all implementations in accordance with the present disclosure. Rather, they are merely examples of apparatuses in accordance with some aspects of the present disclosure as detailed in the appended claims.

Terms used in the present disclosure are merely for the purpose of describing particular embodiments, and are not intended to limit the present disclosure. Unless otherwise defined, technical terms or scientific terms used in the present disclosure shall have general meanings understood by those ordinary skilled in the art to which the present disclosure pertains. “First”, “second” and other similar words used in the specification and claims of the present disclosure do not indicate any sequence, quantity or importance, but are only used to distinguish different components. Similarly, “one” or “a” and other similar words do not mean a quantity limitation, but mean at least one. “A plurality of” or “several” means two or more. Unless otherwise indicated, “front”, “rear”, “lower” and/or “upper” and other similar words are only used for convenience of description, and are not limited to a position or a spatial orientation. “Include” or “comprise” and other similar words mean that elements or items before “include” or “comprise” cover elements or items listed after “include” or “comprise” and their equivalents, but do not exclude other elements or items. “Connect” or “couple” and other similar words are not limited to physical or mechanical connections, and may include electrical connections, whether direct or indirect. Terms determined by “a”, “the” and “said” in their singular forms in the specification of the present disclosure and the appended claims are also intended to include plural forms, unless clearly indicated otherwise in the context. It should also be understood that the term “and/or” as used herein refers to and includes any or all possible combinations of one or more of associated listed items.

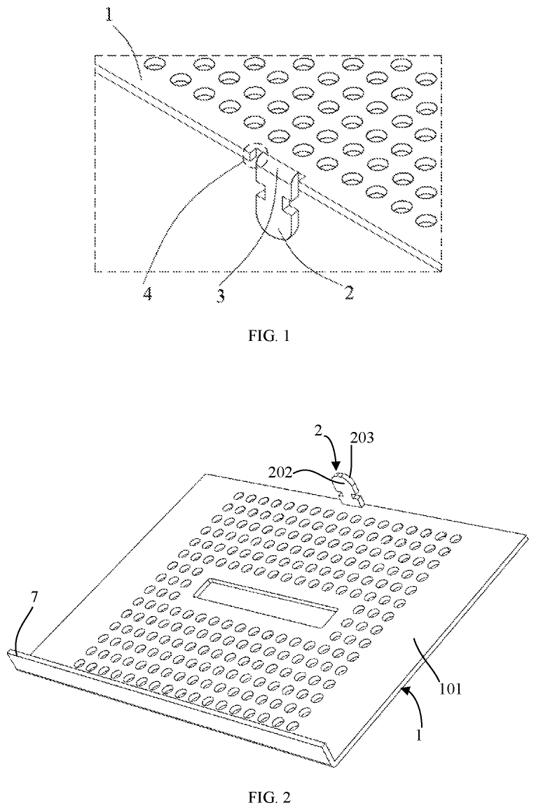

In the related art, as shown in FIG. 1, a snap-fit structure includes a metal plate 1 with a relief 4 and a snap 2 attached to one side of the metal plate 1. The side of the metal plate 1 is formed with an arc-shaped surface 3 with rounded corners in an area corresponding to the snap 2, and has no arc-shaped surfaces in areas other than the area corresponding to the snap 2, resulting in a poor consistency in an appearance of the metal plate 1.

Embodiments of the present disclosure provide a snap-fit structure. As shown in FIGS. 2 to 4, the snap-fit structure includes a metal plate 1 and a snap 2.

The metal plate 1 includes a first plate surface 101 and a second plate surface 102 disposed opposite to each other, and a plate side surface 103 connected between the first plate surface 101 and the second plate surface 102. The snap 2 integrally extends from the first plate surface 101 and includes a first surface 201 contiguous with the plate side surface 103.

In the snap-fit structure according to the embodiments of the present disclosure, the snap 2 is provided on the first plate surface 101 of the metal plate 1, such that the metal plate 1 may be mounted on a workpiece through the snap 2. Meanwhile, the snap 2 includes the first surface 201 contiguous with the plate side surface 103, and the snap 2 integrally extends from the first plate surface 101, thereby preventing an appearance of the metal plate 1 from being affected by the snap 2, and solving the problem of poor consistency in the appearance of the metal plate 1 caused by the rounded corners of the snap 2 in the related art.

The snap-fit structure according to the embodiments of the present disclosure will be described in detail below.

As shown in FIGS. 2 to 4, the metal plate 1 may be a rectangular plate; however, the metal plate 1 may also be a square plate, which is not limited in the present disclosure, and the metal plate 1 may be a circular plate, a trapezoidal plate, a special-shaped plate, etc. The metal plate 1 may be made of stainless steel, aluminium, or the like. The metal plate 1 includes the first plate surface 101, the second plate surface 102, and the plate side surface 103. The first plate surface 101 and the second plate surface 102 are disposed opposite to each other, and the first plate surface 101 and the second plate surface 102 are both perpendicular to a thickness direction of the metal plate 1, that is, the metal plate 1 includes the first plate surface 101 and the second plate surface 102 disposed opposite to each other in the thickness direction. The plate side surface 103 is connected between the first plate surface 101 and the second plate surface 102. The plate side surface 103 is perpendicular to the first plate surface 101, and the plate side surface 103 is also perpendicular to the second plate surface 102. In other embodiments of the present disclosure, the plate side surface 103 may not be perpendicular to the first plate surface 101. The plate side surface 103 may include a first plate side surface, a second plate side surface, a third plate side surface, and a fourth plate side surface that are connected end to end. The first plate side surface is disposed opposite to the third plate side surface, and the second plate side surface is disposed opposite to the fourth plate side surface. In the case that the workpiece is a workpiece included in a speaker device, the metal plate 1 mounted on the workpiece may have a plurality of sound holes 6 provided therein. The metal plate 1 may be further provided with a first mounting hole 5 to mount a speaker indicator, a speaker button, and the like.

As shown in FIGS. 2 to 4, the snap 2 is provided on the metal plate 1. By means of the snap 2, the metal plate 1 may be easily fitted to the workpiece. The snap 2 integrally extends from the first plate surface 101, that is, the snap 2 is structurally integrated with the metal plate 1. The snap 2 may be made of the same material as that of the metal plate 1, and the snap 2 is provided on the first plate surface 101 of the metal plate 1. The snap 2 may extend in a direction perpendicular to the first plate surface 101. The snap 2 includes the first surface 201 contiguous with the plate side surface 103. That is, the first surface 201 of the snap 2 is in contact with and connected to the plate side surface 103, in other words, the first surface 201 of the snap 2 integrally extends from the plate side surface 103. In the case that the plate side surface 103 includes a first plate side surface, a second plate side surface, a third plate side surface, and a fourth plate side surface, for example, the first surface 201 of the snap 2 may be contiguous with the first plate side surface. The first surface 201 may be perpendicular to the first plate surface 101. In the case that the plate side surface 103 is perpendicular to the first plate surface 101, for example, the first surface 201 may be coplanar with the plate side surface 103. Further, the first surface 201 may be coplanar with the first plate side surface.

As shown in FIGS. 2 to 4, the snap 2 may be plate-shaped. In a thickness direction of the snap 2, the snap 2 may include the first surface 201 as described above and a second surface 202 disposed opposite to the first surface 201. That is, the first surface 201 of the snap 2 is perpendicular to the thickness direction of the snap 2. In the case that the first surface 201 is perpendicular to the first plate surface 101, for example, the second surface 202 may also be perpendicular to the first plate surface 101. A junction between the second surface 202 and the first plate surface 101 transitions vertically at a right angle of 90°, without rounded corners. In addition, the snap 2 may further include a side surface 203 connected between the first surface 201 and the second surface 202. The side surface 203 of the snap 2 may be perpendicular to the first surface 201, and the side surface 203 may also be perpendicular to the second surface 202.

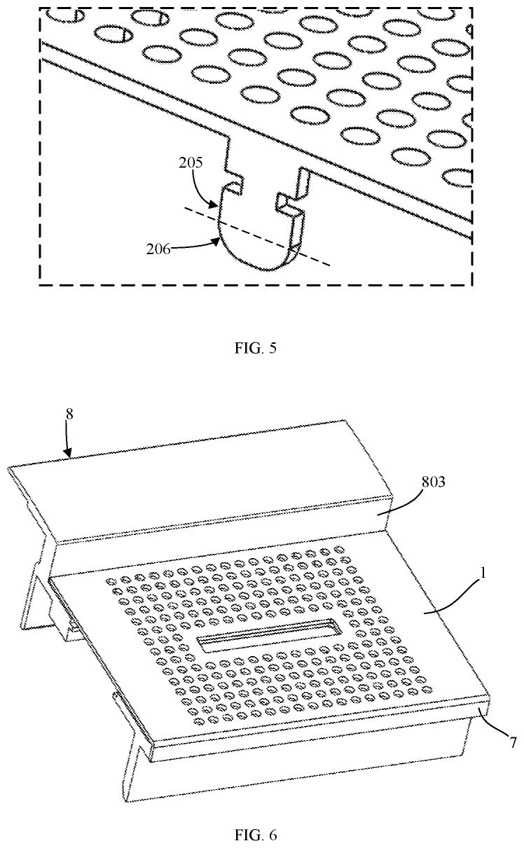

As shown in FIGS. 2 to 5, in an extension direction of the snap 2, the snap 2 may include a first extension section 205 and a second extension section 206 connected with each other, and the second extension section 206 may be located on a side of the first extension section 205 away from the metal plate 1. An end of the first extension section 205 away from the second extension section 206 may be connected to the metal plate 1. The second extension section 206 may have a cross-section that gradually decreases in a direction away from the first extension section 205, such that the snap 2 may be easily placed in a catching groove of the workpiece. In the case that the snap 2 is plate-shaped and includes the first surface 201 and the second surface 202 disposed opposite to each other and the side surface 203 connected between the first surface 201 and the second surface 202, for example, a portion of the side surface 203 at the second extension section 206 may be a smoothly transitioned curved surface, which reduces the resistance to the snap 2 when the snap 2 is placed in the catching groove, such that the snap 2 may be placed in the catching groove more easily.

As shown in FIGS. 2 to 4, the snap 2 may further include a necked portion 204 located between both ends of the snap 2 in the extension direction of the snap 2. The necked portion 204 may have a cross-section smaller than that of a portion of the snap 2 abutting the necked portion 204, that is, the snap 2 forms recesses at the necked portion 204. In the case that the snap 2 is plate-shaped, for example, the portion of the snap 2 abutting the necked portion 204 has a thickness equal to that of the necked portion 204. That is, although the cross-section of the necked portion 204 is reduced, the thickness of the necked portion 204 is not reduced. Since the snap 2 is formed with the necked portion 204, that is, recesses are formed in the snap 2, the snap 2 may be prevented from being disengaged from the catching groove. In other embodiments of the present disclosure, the snap 2 may include a plurality of necked portions 204 distributed at intervals in the extension direction of the snap 2.

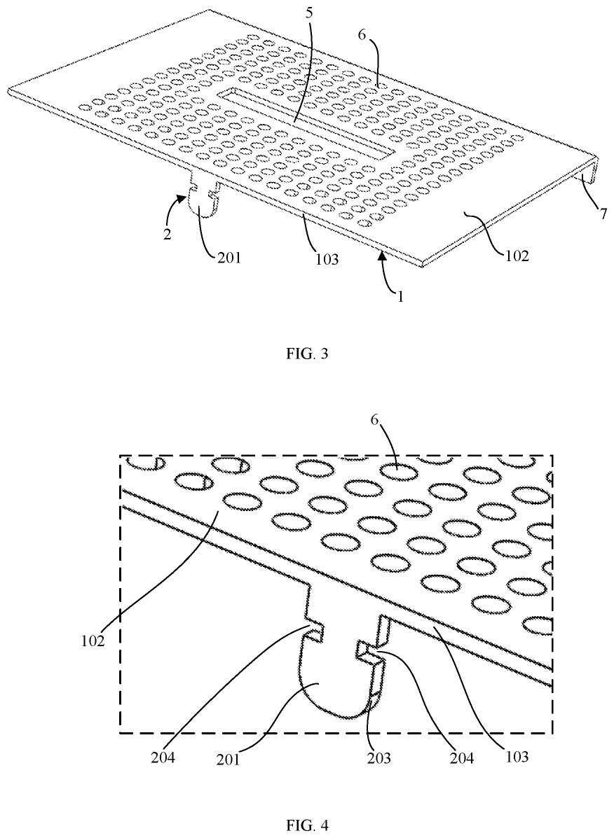

As shown in FIGS. 2 and 3, the snap-fit structure according to the embodiments of the present disclosure may further include a bending portion 7. The bending portion 7 integrally extends from the plate side surface 103, that is, the bending portion 7 is structurally integrated with the metal plate 1. The bending portion 7 may be made of the same material as the metal plate 1. The bending portion 7 may also be plate-shaped, which is not particularly limited in the embodiments of the present disclosure. In the case that the plate side surface 103 includes a first plate side surface and a third plate side surface disposed opposite to each other and the first surface 201 of the snap 2 is contiguous with the first plate side surface, for example, the bending portion 7 may integrally extend from the third plate side surface. A size of the bending portion 7 may be equal to that of the third plate side surface in a direction perpendicular to the thickness direction of the metal plate 1 and parallel to the third plate side surface. In the case that the bending portion 7 is plate-shaped, for example, the bending portion 7 has opposite end surfaces in the direction perpendicular to the thickness direction of the metal plate 1 and parallel to the third plate side surface, with one end surface of the bending portion 7 being coplanar with the second plate side surface, and the other end surface of the bending portion 7 being coplanar with the fourth plate side surface, such that the size of the bending portion 7 is equal to that of the third plate side surface. The bending portion 7 and the snap 2 may be located on the same side of the metal plate 1 in the thickness direction of the metal plate 1, such that a catching space is formed between the bending portion 7 and the snap 2. The bending portion 7 may extend in the same direction as the snap 2; however, the bending portion 7 may also extend in a different direction from the snap 2. In the case that the bending portion 7 extends in the same direction as the snap 2 and the extension direction of the snap 2 is perpendicular to the first plate surface 101, for example, an extension direction of the bending portion 7 may also be perpendicular to the first plate surface 101. In the case that the snap 2 is plate-shaped, for example, the plate-shaped bending portion 7 may be parallel to the snap 2, that is, the thickness direction of the snap 2 is parallel to a thickness direction of the bending portion 7. By holding the workpiece in the catching space between the snap 2 and the bending portion 7, the metal plate 1 may be securely mounted to the workpiece.

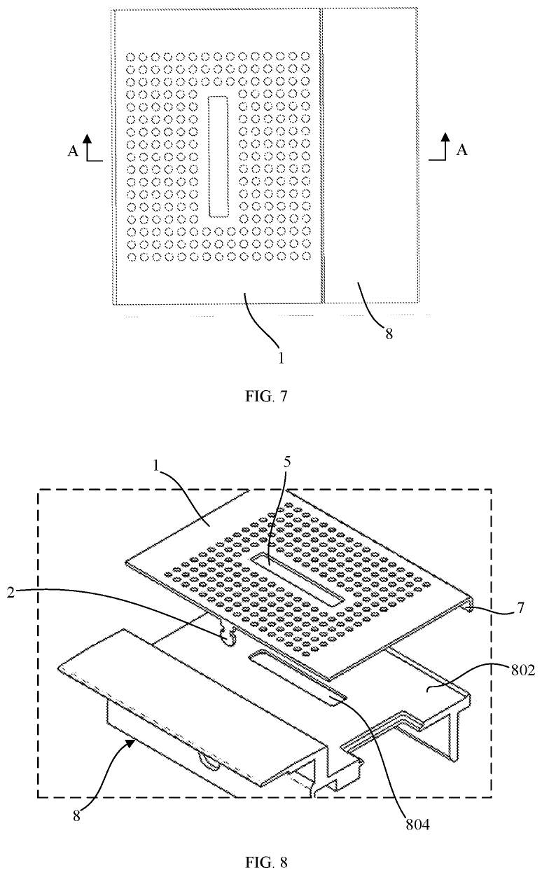

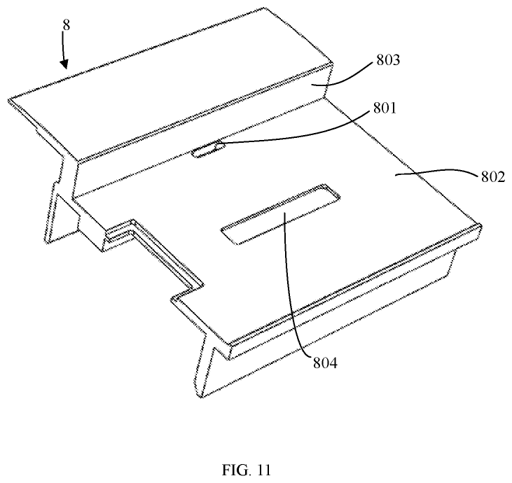

Embodiments of the present disclosure further provide an assembly structure. As shown in FIGS. 6, 7, and 11, the assembly structure may include a workpiece 8 and the snap-fit structure according to any of the above embodiments. The workpiece 8 is provided with a catching groove 801. The snap 2 of the snap-fit structure may be fitted in the catching groove 801. The workpiece 8 may be a workpiece included in a speaker device, which is not particularly limited in the embodiments of the present disclosure. Since the snap-fit structure included in the assembly structure according to the embodiments of the present disclosure is the same as the snap-fit structure according to the above embodiments, the snap-fit structure included in the assembly structure according to the embodiments of the present disclosure has the same beneficial effects as the snap-fit structure according to the above embodiments, which will not be repeated in the present disclosure.

As shown in FIGS. 2, 3, and 8 to 11, the workpiece 8 may include an assembly surface 802 and a stop surface 803. The assembly surface 802 may be perpendicular to the stop surface 803. The catching groove 801 may be provided in the assembly surface 802, that is, the assembly surface 802 has a recess to form the catching groove 801. After the snap 2 is fitted in the catching groove 801, the first plate surface 101 of the metal plate 1 mates with the assembly surface 802, and the plate side surface 103 of the metal plate 1 mates with the stop surface 803. In the case that the plate side surface 103 of the metal plate 1 includes a first plate side surface and a third plate side surface disposed opposite to each other and the first surface 201 of the snap 2 is contiguous with the first plate side surface, for example, the plate side surface 103 mates with the stop surface 803, that is, the first plate side surface mates with the stop surface 803. The first plate surface 101 mates with the assembly surface 802, that is, the first plate surface 101 is in close contact with the assembly surface 802; and the plate side surface 103 of the metal plate 1 mates with the stop surface 803, that is, the plate side surface 103 of the metal plate 1 is in close contact with the stop surface 803. In addition, a flexible membrane 9 may be provided on the stop surface 803, and the plate side surface 103 may abut against the flexible membrane 9. The flexible membrane 9 may act as a cushion when the plate side surface 103 and the stop surface 803 are pressed against each other, to prevent the plate side surface 103 from coming into metal-to-metal contact with the stop surface 803. The flexible membrane 9 may be a soft fabric; however, the flexible membrane 9 may also be a rubber product or the like. In addition, the workpiece 8 may be further provided with a second mounting hole 804. After the snap 2 is fitted in the catching groove 801 of the workpiece 8, the second mounting hole 804 may communicate with the first mounting hole 5 to jointly accommodate a speaker indicator, a speaker button, and the like.

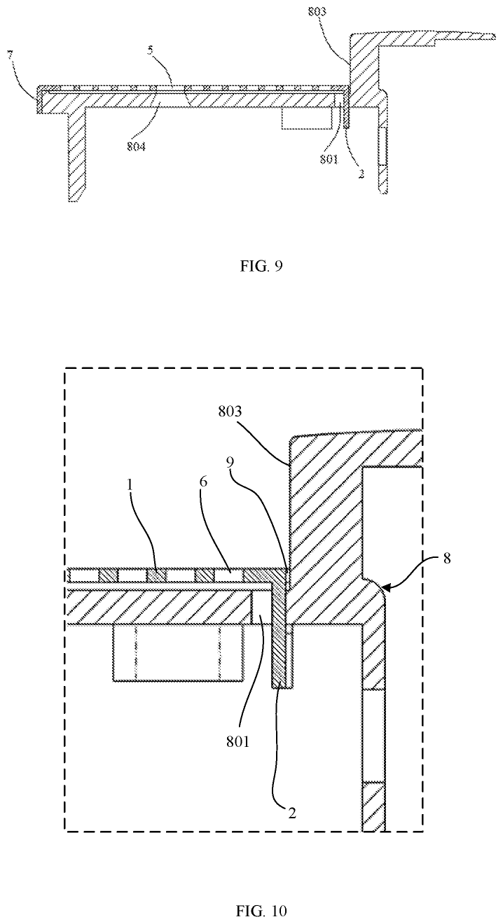

As shown in FIGS. 9 and 10, in the case that the snap-fit structure includes the above-mentioned bending portion 7, for example, after the snap 2 is fitted in the catching groove 801 of the workpiece 8, a portion of the workpiece 8 is located in the catching space between the bending portion 7 and the snap 2. Further, in the case that the snap 2 includes the first surface 201 and the second surface 202 disposed opposite to each other, for example, after the snap 2 is fitted in the catching groove 801 of the workpiece 8, a gap is formed between the second surface 202 of the snap 2 and a side wall of the catching groove 801, that is, a size of the catching groove 801 is greater than a size of the snap 2 in the thickness direction of the snap 2. There is a gap between the second surface 202 of the snap 2 and the side wall of the catching groove 801, which not only provides convenience for the mounting of the snap-fit structure and the workpiece 8, but also provides a certain degree of freedom for the snap-fit structure mounted on the workpiece 8 to avoid damage to the snap-fit structure when it is squeezed.

The above are merely some embodiments of the present disclosure, and not intended to limit the present application in any form. Although the present disclosure has been disclosed as above in some embodiments, the present disclosure is not limited thereto. Any person skilled in the art may utilize the technical contents disclosed above to make some variations or modifications into equivalent embodiments with equivalent changes, without departing from the scope of the present disclosure. However, without departing from the contents of the present disclosure, any simple variations, equivalent changes and modifications made to the above embodiments based on the technical essence of the present disclosure still fall within the scope of the present disclosure.

1. A snap-fit structure, comprising:
a metal plate comprising a first plate surface and a second plate surface disposed opposite to each other, and a plate side surface connected between the first plate surface and the second plate surface; and
a snap integrally extending from the first plate surface and comprising a first surface contiguous with the plate side surface.

2. The snap-fit structure according to claim 1, wherein the first surface is perpendicular to the first plate surface.

3. The snap-fit structure according to claim 1, wherein in an extension direction of the snap, the snap comprises a first extension section and a second extension section connected with each other, and the second extension section is located on a side of the first extension section away from the metal plate and has a cross-section that gradually decreases in a direction away from the first extension section.

4. The snap-fit structure according to claim 1, wherein the snap is plate-shaped, and the first surface is perpendicular to a thickness direction of the snap.

5. The snap-fit structure according to claim 4, wherein
the snap comprises a second surface disposed opposite to the first surface and a side surface connected between the first surface and the second surface;
in an extension direction of the snap, the snap comprises a first extension section and a second extension section connected with each other, and the second extension section is located on a side of the first extension section away from the metal plate and has a cross-section that gradually decreases in a direction away from the first extension section; and
a portion of the side surface of the snap at the second extension section is a smoothly transitioned curved surface.

6. The snap-fit structure according to claim 4, wherein the snap comprises a necked portion located between both ends of the snap in an extension direction of the snap, and the necked portion has a cross-section smaller than that of a portion of the snap abutting the necked portion.

7. The snap-fit structure according to claim 4, further comprising a bending portion integrally extending from the plate side surface, the bending portion and the snap being located on a same side of the metal plate in a thickness direction of the metal plate, such that a catching space is formed between the bending portion and the snap.

8. The snap-fit structure according to claim 7, wherein the bending portion extends in a same direction as the snap.

9. The snap-fit structure according to claim 8, wherein the bending portion is plate-shaped and is parallel to the snap.

10. An assembly structure, comprising:
a workpiece provided with a catching groove; and
the snap-fit structure according to claim 1, wherein the snap can be fitted in the catching groove.

11. The assembly structure according to claim 10, wherein the workpiece comprises an assembly surface and a stop surface, the catching groove is provided in the assembly surface, the first plate surface mates with the assembly surface, and the plate side surface mates with the stop surface.

12. The assembly structure according to claim 11, wherein a flexible membrane is provided on the stop surface, and the plate side surface abuts against the flexible membrane.

13. An assembly structure, comprising:
a workpiece provided with a catching groove; and
the snap-fit structure according to claim 7, wherein the snap can be fitted in the catching groove.

14. The assembly structure according to claim 13, wherein a portion of the workpiece is located in the catching space between the bending portion and the snap.

15. The assembly structure according to claim 13, wherein the snap comprises a second surface disposed opposite to the first surface, and a gap is formed between the second surface and a side wall of the catching groove.
